(19) United States
(12) Patent Application Publication
(10) Pub. No.: US 2012/0301254 A1
(43) Pub. Date: Nov. 29, 2012

(54) System and Method for Receiving and Feeding Used Beverage Containers (UBC) to at Least One Conveyor

(75) Inventor: Knud Steen Støvring, Asperup (DK)

(73) Assignee: Anker Andersen A/S, Torring (DK)

(21) Appl. No.: 13/513,215

(22) PCT Filed: Dec. 1, 2010
(86) PCT No.: PCT/DK2010/050328

§ 371 Date: Aug. 14, 2012

(30) Foreign Application Priority Data
Dec. 1, 2009 (DK) PA 2009 70238

(51) Int. Cl. B65G 47/14

(52) U.S. Cl. 414/305; 414/808

(57) ABSTRACT

A system and a method for receiving and feeding used beverage containers (UBC) uses at least one conveyer and a receptacle with a variable volume for receiving batches of UBC's. The batch receptacle has a small footprint. An annular rotating ring located at the upper edge of the receptacle circumscribes a piston when placed in the upper position. The receptacle has a receiving cylinder. The receiving cylinder has a piston, which is moved by at least one actuator. The system provides a very effective and very small receptacle for all kinds of packaging which has to be returned either for refill or for reuse of the material, or the system can be used for collecting highly polluting used articles such as batteries or other containers containing chemicals. The receptacle has a variable volume that can be filled up with UBC's.

### FIELD OF THE INVENTION

The present invention relates to a system and a method for receiving and feeding UBC's to at least one conveyer, which system comprises a receptacle for receiving UBC's, which receptacle comprises a peripheral barrier circumscribing at least a portion of the receptacle, which system comprises at least one conveyor provided relative to the receptacle, at which receptacle the UBC's are forced to move mostly radial towards the conveyer.

### BACKGROUND OF THE INVENTION

A reverse vending machine (RVM) is a machine that accepts counts, validates and classifies used beverage containers in the following referred to as “UBC's”—used beverage containers may also be referred to as “empties”. The UBC's are automatically identified and registered, typically by scanning the barcode. On the basis of the barcode information the UBC's are validated against a barcode database, which tells if the barcode triggers a refund of the UBC's and the UBC's are classified according to the information of the barcode database into different material fractions (e.g. clear PET, coloured PET, glass, aluminium and steel) making subsequent sorting of the UBC's into the different material fractions possible. If the barcode database triggers a refund, money (representing the returned deposit fee) is returned to the RVM user, typically in form of a voucher which is automatically dispensed by the RVM. This printed voucher can be redeemed in the shop where RVM's typically are located. Breweries, bottleries and manufacturers of mineral water, soft drinks and the like frequently use refillable or non refillable bottles made of plastic, glass or metal cans that are part of a deposit/refund system. Each used beverage container (in the following also referred to as “UBC”) represents a deposit fee that has an effect on manufacturers, distributors, retailer and consumers motivating the consumers to return the UBC's in the shops, where the returned UBC's are counted and registered, typically in manually fed Return Vending Machines (RVM), or manually accepted by the cashier whereby the consumer gets the refund. In many cases the UBC's are transported to central counting centres, where the UBC's are counted and registered once more and sorted into the different material fractions e.g. clear PET, coloured PET, glass, aluminium and steel. Based upon the counting and registration at the counting centre the manufacturers and/or distributors are invoiced for the deposit fee, which amount is collected by the shops. After counting and registration the refillable UBC's are typically returned to the manufacturer, washed, rinsed and refilled whereas the non refillable UBC's are devaluated in e.g. compactors, shredders etc. and the residual products sent to recycling. Used beverage containers may also be referred to as “empties”. A batch is a quantity or number of UBC's coming at one time or taken together. A batch may be the content of one or more bags/sacks. Other synonyms for the term “batch” could be: group, lot, bunch, set, pack, portion or consignment.

A system for processing of packages, such as recyclable UBC's, is known from WO 2006/125436 A1. In this system, UBC's are recorded, counted and sorted in a counting and sorting machine. The UBC's are automatically fed to the recording unit. Large numbers of UBC's can be handled per time unit. Due to the high capacity of this system, it may be referred to as a high speed counting and sorting machine.

Other feeding systems for automatic feeding of used UBC's are known from WO 2009/124556 entitled “An apparatus and method for feeding used UBC's” and from U.S. provisional application No. 61/250,088 filed Oct. 9, 2009 entitled “Disk feeder for feeding used UBC's”. These systems are based on one or more rotating disks. In WO 2009/124556 it was disclosed that conveyor bands could be provided to forward UBC's between the disks to increase the load capacity of the feeding apparatus. U.S. provisional application No. 61/250,088 showed that the load capacity could be increased in a cost-effective way by increasing the number of disks. However, increasing the number of disks also increases the footprint of the feeding apparatus. An object of the present invention is therefore to provide a high capacity automated feeding system which is still cost-effective and simple in functionality but with a low footprint.

### OBJECT OF THE INVENTION

It is the object of the invention to achieve a system for receiving batches of UBC's at a receptacle with an variable volume. A further object of the invention is to achieve a batch receptacle with a small footprint.

### DESCRIPTION OF THE INVENTION

The object can be fulfilled a system as described in the preamble to claim 1 and further modified in that the receptacle comprises an annular rotating ring located at the upper edge of the receptacle and circumscribing the piston when placed in the upper position, which receptacle comprises a receiving cylinder, which receiving cylinder comprises a piston, which piston is moved by at least one actuator, which actuator moves the piston inside the receiving cylinder between a first and a second end position.

By the system as indicated above, it is possible to achieve a very effective and very small receptacle for all kinds of packaging which has to be returned either for refill or for reuse of the material, or the system can be used for collecting highly polluting used articles such as batteries or other containers containing chemicals. The fact that the receptacle comprises a variable volume this volume can be filled up with UBC's. Therefore, the footprint of the receptacle is relatively limited in relation to the actual volume that can be rotated and moved up unto a conveyer where the UBC's can be sorted into different groups. Especially, if the piston is working automatically so that the level of the piston is depending on the actual volume of UBC's at the piston, a highly effective system can be achieved. An alternative possibility is always letting the piston be placed as low as possible during the filling up of the volume. As soon as the process starts then the piston will move into a position where the items easily can be moved unto rotating ring and further to the conveyer. By continuously moving the piston upwards, there will always be UBC's that will be moved unto the rotating ring and further onto the conveyer and, in that way, removed. In fact the volume can be as big as a half cubic meter, and the efficiency of the system can be so high that half a cubic meter of UBC's will be removed in a very short time which probably is less than two minutes. The receptacle comprises an annular rotating ring located at the upper edge of the receptacle. By placing a rotating ring at the upper position of the piston, it is possible to let the piston be non-rotating and let the ring perform all the rotation. It is also possible to let both the ring and the piston rotate or in some situations, it could maybe be necessary to let the piston rotate in the opposite direction. The use of the ring placed close to a barrier can let the UBC's rotate in a way where the UBC's are forced outwards, and as soon as they pass one or more openings toward a conveyer they fall out of the receptacle onto a conveyer placed close to the receptacle where the conveyer will perform further transportation. The ring can be mostly horizontally flat, but in some situation, if the speed of the UBC's towards the conveyor band is to be increased, also a ring that is conical, so the UBC's are being directed outwards towards the conveyor automatically, can be used.

The system can be controlled by a computer controlled system which can control detectors and also actuators. The actuators can be constructed in different ways. One possible way of moving a piston upwards and downwards is by rotating the spindle. By rotating the spindle, the piston can move up and down along the spindle. Another possibility is to use a pressurised medium for moving the piston. It should be possible to move the piston by pneumatic, hydraulic or electric actuators. Water could be used as a hydraulic medium. Another possible actuator is an electric motor for performing a linear movement of the piston. In that way spindle actuators could be used.

At least the upper surface of the piston can be rotated by a motor, which motor is controlled by the control system. By performing rotation of the piston the UBC's will rotate and centrifugal forces will move the UBC's outwards towards the outer periphery of the ring. At the periphery of the receptacle it is the UBC's leaves the piston through an opening in the peripheral barrier unto a conveyor band. In that way a highly effective and very fast movement of a batch of UBC's unto a band is achieved.

The piston can comprise a mostly conical upper surface for guiding UBC's on the piston towards the periphery thereof. By performing the piston with a conical form, it is possible that the UBC's are automatically moved outwards by gravity in the direction of the periphery, so together with the forces provided by rotation, a more effective movement of the UBC's is performed.

The system can comprise means for registering the level of UBC's in the receptacle. In order to perform the transportation of UBC's most efficiently, it is necessary for the system to measure the level of the UBC's during the process. That measurement can be performed by optical cells and light beams, or it could be performed by ultra sound measurement.

The invention also concerns a method for receiving batches of UBC's, receiving a batch of object at a receptacle, and perform rotation of the UBC's, and perform aligning of UBC's along a barrier, and forward the object to a conveyer arranged in relation to the barrier, and perform measurement of the volume of UBC's at the receptacle, and transmit the value of the measured volume of UBC's to a control system, and calculate new position for the receptacle in relation to the actual occupied volume of UBC's at the receptacle, and perform an adjustment of the receptacle in mostly vertical direction, and repeat the method in order to adjust the volume at the receptacle in relation to the actual number of UBC's at the receptacle.

It is possible to operate a receptacle with an adjustable volume, so that the actual empty volume is adjusted in accordance with the number of UBC's that are filled into the receptacle. By automatically adjusting the level of a piston, it is possible to achieve a very high efficiency of a system. There will always be UBC's on their way to the conveyer, because the piston is moved upwards slowly so more of the UBC's are transported out at the conveyer and moved forwards in the system. The automatic adjustment of volume increases the actual speed of the transportation of the UBC's, because the capacity can be used nearly up to 100 percent and without risk of losing too many UBC's, because the speed is too high of the piston upwards. In that way a highly effective system can be achieved.

The system or method can be used as a reverse vending system for efficient and automatic registration of a batch of used UBC's from a user. It will be rather easy to use the receptacle as part of an automat which is used for receiving a batch of UBC's such as, for example, bottles. So instead of as usual filling in one bottle at the time at a conveyor, it is possible to fill in a batch of UBC's as, for example, a bag full of empty bottles can be filled in the machinery at once, and automatic counting and payback can be performed. That will lead to an increased service for the users who have to return empty bottles or other kinds of containers or other packaging products that have to be sent back for reuse. Especially in the future we must accept a higher degree of recycling of empty articles, simply because the cost of new materials is increasing. Therefore, more and more food containers or containers for medical products have to be returned for recycling of the material they are made of.

### DESCRIPTION OF THE DRAWING

FIGS. 1a) to 1d) show illustrations of different positions of a piston in one possible embodiment of the invention.

FIG. 2a) shows an alternative embodiment for the invention.

FIG. 2b) shows a sectional view of the same embodiment as FIG. 2a)

FIG. 2c) shows same embodiment as FIG. 2b), but now the piston 103 is indicated in its upper position.

FIG. 2d) shows a top view of the same embodiment as disclosed at the a), b) and c) figs.

FIG. 3a), b), c) and d) shows an alternative embodiment to that embodiment indicated at FIG. 2.

FIG. 4a), b), c) and d) disclose an alternative embodiment to the FIGS. 2 and 3

### DETAILED DESCRIPTION OF THE INVENTION

The UBC's as described in the claims concerns refillable or non refillable bottles made of plastic, glass or metal cans that can be part of a deposit/refund system. The object can also concern all kind of containers that has to be collected for recycling.

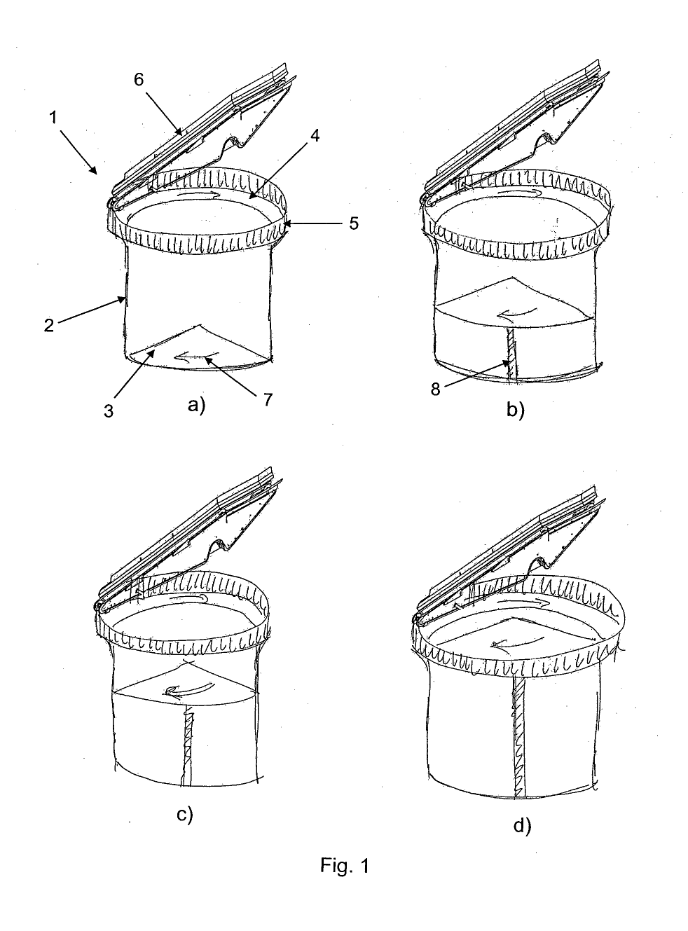

With reference to FIG. 1a) the apparatus 1 comprises a receptacle 2, in this case a cylinder, with a conical shaped piston 3 at the bottom of the cylinder 2. The ring 4 is encircled by the peripheral barrier 5 and the ring 4 is located at, the upper edge of the cylinder 2. A conveyor 6 is arranged in relation to the ring 4. In this embodiment the cylinder 2, the ring 4 and the piston 3 rotates together in a clockwise direction indicated by the arrow 7. FIGS. 1a)-d) are cut through illustrations, i.e. the piston 3 can bee seen through the side wall of the receptacle 2. No UBC's are indicated in the figures.

In FIG. 1b) the piston 3 has been translated vertically towards the ring 4 by means of translation element 8. In FIG. 1c) the piston 3 is lifted further towards the ring 4 and in FIG. d) the piston 3 is almost horizontally aligned with the ring 4. FIGS. 1a)-d) show piston 3 positions in different phases of the feeding process, i.e. UBC's can be loaded into the receptacle 2 when the volume is as large as possible in FIG. 1a). While UBC's are arranged onto the conveyor 6, the piston 3 is gradually raised towards the ring 4 in FIGS. 1b) to 1d) in order for the remaining UBC's in the receptacle to be guided onto the ring and subsequently onto the conveyor 6.

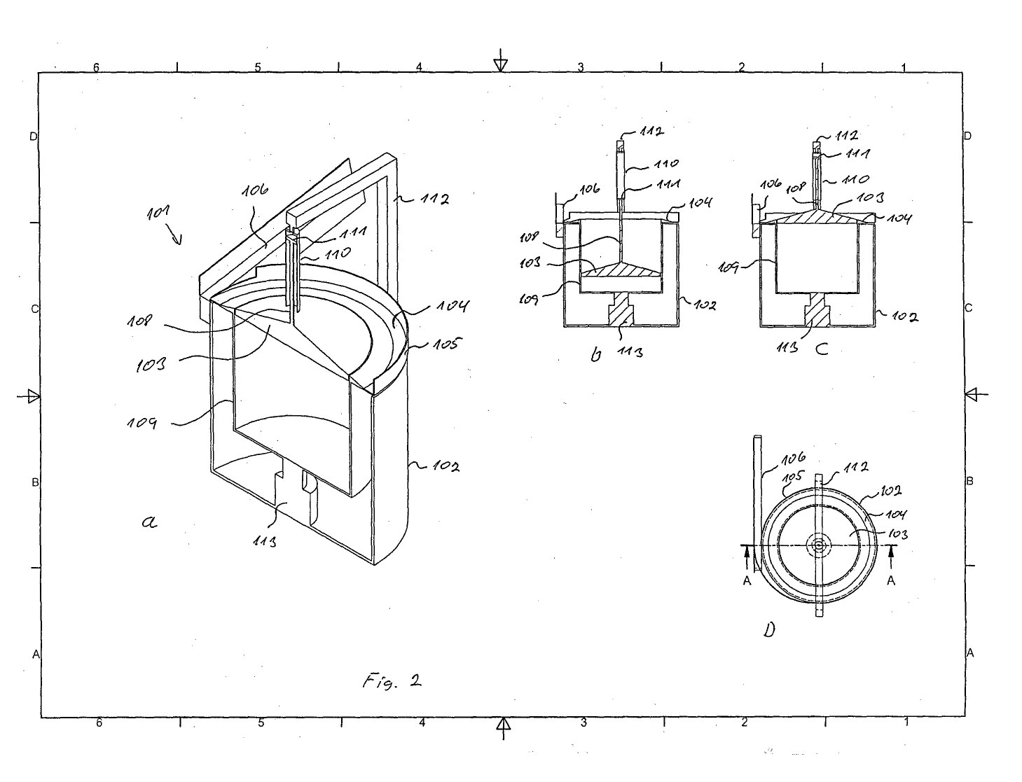

FIG. 2a) shows an alternative embodiment for the invention disclosing a system 101 which comprises a receptacle 102 comprising a cylinder 109 in which cylinder there is placed a conical piston 103. A rotating ring 104 is placed and rotating at the upper edge of the cylinder. The ring 104 is encircled by a peripheral barrier 105. A conveyor 106 is arranged in relation to the rotating ring 104. The piston 103 is carried by a shaft 108 which shaft is placed in a cylinder 110 which cylinder comprises further a piston 111. The cylinder 110 is carried by a fixture 112. The cylinder 109 is carried by an actuator 113 for rotating the cylinder 109.

FIG. 2b) shows a sectional view of the same embodiment as FIG. 2a) and only differences will be mentioned. The only major difference that occurs is that the piston 103 is now indicated in its lower position.

FIG. 2c) shows same embodiment as FIG. 2b), but now the piston 103 is indicated in its upper position.

FIG. 2d) shows a top view of the same embodiment as disclosed at the a), b) and c) figs. Only the fixture 112 is different and it can here be seen that the fixture is forming a bridge for carrying the cylinder 110 and the piston 103.

In operation it is to be understood that the ring 104, which may be partly conical, is rotating and the piston 103 at the different embodiments of FIG. 2 is non-rotating, where instead the cylinder 109 is rotated by the actuator 113. The actuator could be an electric motor or it could be a hydraulic pneumatic motor. It can be seen that when the piston 103 is placed in its lower position, there is a relatively big volume for receiving UBC's above the piston. During the sorting process UBC's will all the time be delivered to the conveyor 106 and the piston 103 can by the actuator made by the piston and cylinder 111 110 it is possible by pneumatic or hydraulic means to move the piston between its end positions. When the piston 103 in the FIG. c) enters its top position, it is clear that all UBC's placed at the piston 103 will, because of the conical form, automatically fall out at the rotating ring 104.

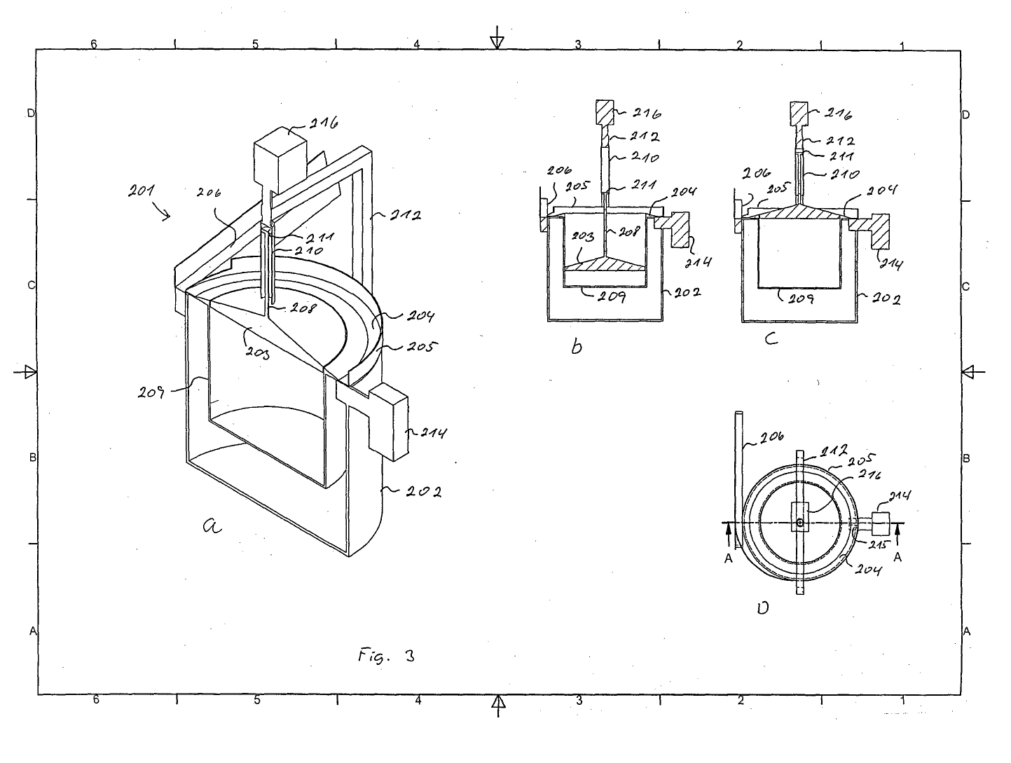

FIG. 3 shows an alternative embodiment to that embodiment indicated at FIG. 2, therefore all reference numbers are added by 100 in relation to the FIG. 2. The single reference numbers are therefore not directly mentioned where they are identical to what is seen at the FIG. 2. At FIG. 3 is indicated an actuator 216 for rotating the cylinder 210 and the piston 211, the shaft 208 and the piston 203. In that way it is possible that the cylinder 219 is non-rotating. Instead there is also indicated an actuator 214 for rotating the ring 204. Especially at the FIG. 3d) is indicated that a toothed wheel 215 rotates the ring 204. By rotating the piston 203, but not rotating the cylinder 209, but rotating the ring 204, it is possible in a highly effective way to move the UBC's from the surface of the piston 203 unto the rotating ring 204 and further unto the conveyor 206. The conveyor 206 is indicated in a direction perpendicular to an axis through the system. In an alternative embodiment, it is possible to connect the conveyor 206 at other positions and in that way transport the UBC's in different directions.

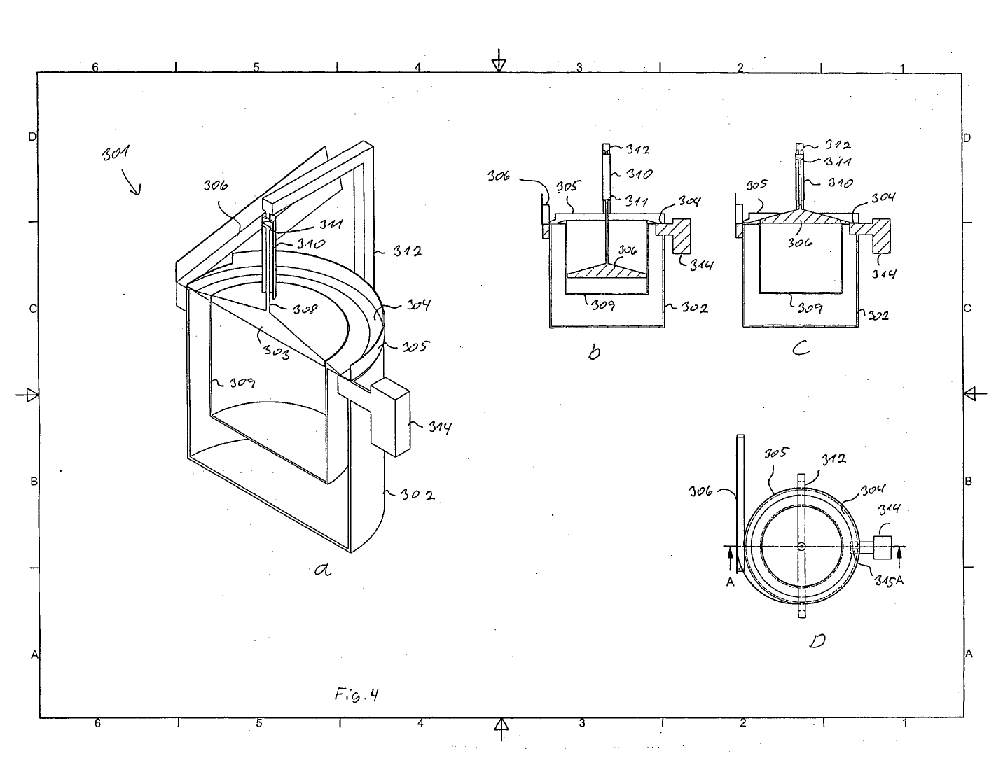

FIG. 4a), b), c) and d) disclose an alternative embodiment to the FIGS. 2 and 3, but most of the technical features are the same, therefore all numbers again added with 100 with reference to the FIG. 3. All previous mentioned features will not be described further. The difference to FIG. 3 is that the actuator 314 rotates the ring 304, but the piston 303 and the cylinder 309 is non-rotating. The rotating of the ring 304 is performed by the actuator 314 by a toothed wheel 315. Because the conical surface at the piston 306 and the conical section of the top of the cylinder 309, the UBC's placed at the piston 306 will by the conical form automatically by gravity fall out at the rotating ring 304 and in that way be transported to the conveyor 306.

In that way a relatively simple embodiment for the invention can be performed. It is to be understood that different kinds of actuators could be used for moving the piston 303. At the fig. are only indicated actuators placed above the piston, but also different kinds of hydraulic or pneumatic actuators could be placed below the piston 306.

1. A system for receiving and feeding UBC's to at least one conveyer, which system comprises a receptacle for received UBC's, which receptacle comprises a peripheral barrier circumscribing at least a portion of the receptacle, which system comprises at least one conveyor provided mostly tangential to the receptacle, at which receptacle the UBC's are forced to move mostly radial direction towards the conveyer, wherein the receptacle further comprises an annular rotating ring located at the upper edge of the receptacle and circumscribing the piston when placed in the upper position, which receptacle comprises a receiving cylinder, which receiving cylinder comprises a piston, which piston is moved by at least one actuator, which actuator moves the piston inside the receiving cylinder between a first and a second end position.

2. A system according to claim 1, wherein that the receptacle comprises a control system, which control system comprises at least detections means for detecting the position of the piston, which control system performs control of the actuator.

3. A system according to claim 1, wherein the piston is rotated by a motor, which motor is controlled by the control system.

4. A system according claim 1, wherein the cylinder is rotated by a motor, which motor is controlled by the control system.

5. A system according claim 1, wherein the cylinder and the ring is rotated by a motors, which motors is controlled by the control system.

6. A system according claim 1, wherein the piston and the ring is rotated by a motors, which motors is controlled by the control system.

7. A system according to claim 1, wherein the piston comprises a partly conical upper surface for guiding UBC's on the piston towards the periphery thereof.

8. A system according to claim 1, wherein the system comprising means for registering the degree of filling of UBC's in the receptacle.

9. A method for receiving batches of UBC's, which method comprises at least the following steps:
a. receiving a batch of UBS's at a receptacle,
b. rotating the UBC's,
c. aligning the UBC's along a barrier,
d. forwarding the UBS's to a conveyer arranged in relation to the barrier,
e. measuring the degree of filling of UBS's at the receptacle,
f. transmitting a value of the measured degree of filling of UBC's to a control system
g. calculating a new position for the receptacle in relation to the measured degree of filling of UBC's at the receptacle,
h. performing an adjustment of the receptacle in mostly vertical direction,
i. repeating steps e-f in order to adjust the degree of filling at the receptacle in relation to the actual number of UBC's at the receptacle.

10. Use of a system as described in claim 1, wherein the system or method is used as a reverse vending system for efficient and automatic registration of a batch of used UBC's from a user.
